(19) United States
(12) Patent Application Publication
(10) Pub. No.: US 2013/0212153 A1
(43) Pub. Date: Aug. 15, 2013

(54) COMPUTER IMPLEMENTED METHOD, WEB SERVER, CLIENT COMPUTING DEVICE AND COMPUTER READABLE STORAGE MEDIUM FOR SELECTIVELY RELATING EVENT DATA

(71) Applicant: John Edward Hall, Sydney (AU)

(72) Inventor: John Edward Hall, Sydney (AU)

(21) Appl. No.: 13/430,299

(22) Filed: Mar. 26, 2012

(30) Foreign Application Priority Data
Mar. 25, 2011 (AU) 2011901103

(51) Int. Cl. H04L 29/06

(52) U.S. Cl. CPC H04L 29/06047
USPC 709/203

(57) ABSTRACT

The present disclosure relates a computer implemented method and server for selectively relating event data. The event data may relate to objects, individuals, companies and the like. Furthermore, the computer implemented method is adapted for identifying related events in accordance with the first event data and the second event data. In this manner, and in one embodiment, a chronicler, having input first event data using the computer implemented method, may be alerted to other events related to the first event.

### FIELD OF THE INVENTION

The present invention relates to a computer implemented method, web server, client computing device and computer readable storage medium for selectively relating event data

The invention has been developed primarily for use in online web applications and will be described hereinafter with reference to this application. However, it will be appreciated that the invention is not limited to this particular field of use.

### BACKGROUND OF THE INVENTION

Existing online social applications allow users to input various information such as personal details, status updates, event information and the like. Furthermore, existing online social network applications allow a user to build a social network by inviting one or more other users to join the user's social network. Alternatively, existing online social network applications are configured to selectively relate users by suggesting other users for inclusion within a user's social network. Such suggested users are usually users related to the user by the second or more degree.

However, while existing online social applications are adapted to selectively relate users, existing online social applications are limited to selectively relating users in accordance with the degree of connection between the users.

As such, it would be advantageous for a computer implemented method, web server, client computing device and computer readable storage medium to be adapted for selectively relating users by other means, such as in accordance with user information inputted by a user.

Furthermore, as stated above, existing online social applications allow users to input event information, such as, for example, event information relating to an upcoming birthday celebration. However, existing online social applications suffer from the disadvantage of failing to utilize the event data in selectively relating users. Furthermore, existing online social applications lack capability to selectively relate one or more events in accordance with the event data. Existing online social applications furthermore only allow users to enter event data for events occurring in the future.

As such, it would be advantageous for a computer implemented method, web server, client computing device and computer readable storage medium to be adapted for selectively relating event data in accordance with the event data.

It is to be understood that, if any prior art information is referred to herein, such reference does not constitute an admission that the information forms part of the common general knowledge in the art, in Australia or any other country.

### SUMMARY OF THE INVENTION

The claimed invention seeks to provide a computer implemented method, web server, client computing device and computer readable storage medium adapted for selectively relating event data which will overcome or substantially ameliorate at least some of the deficiencies of the prior art, or to at least provide an alternative.

According to one aspect of the present invention, there is provided a computer implemented method for selectively relating event data, the method comprising the steps of:
receiving first event data representing a first event;
receiving second event data representing a second event; and
selectively relating the first event data and the second event data in accordance with the first event data and the second event data.

Advantageously, the computer implemented method is adapted to receive event information relating to objects, individuals, companies and the like. Furthermore, the computer implemented method is adapted for identifying related events in accordance with the first event data and the second event data. In this manner, and in one embodiment, a chronicler, having input first event data using the computer implemented method, may be alerted to other events related to the first event. Furthermore, the computer implemented method may introduce the chronicler to other chroniclers having similar interests or backgrounds in accordance with the event data.

Preferably, the first event data comprises first location data representing a location of the first event; and
the second event data comprises second location data representing a location of the second event, and wherein:
the step of selectively relating the first event data and the second event data in accordance with the first event data and the second event data comprises the step of:
selectively relating the first event data and the second event data in accordance with the first location data and the second location data.

Advantageously, the computer implemented method is adapted for matching events by location. For example, should a first chronicler have attended a particular university, the computer implemented method may be adapted to identify other chroniclers having attended the same university.

Preferably, the step of selectively relating the first event data and the second event data in accordance with the first location data and the second location data comprises the steps of:
determining distance data in accordance with the first location data and the second location data representing a distance between the location of the first event and the location of the second event; and
selectively relating the first event data and the second event data in accordance with the distance data.

Advantageously, the computer implemented method is adapted for matching events having adjacent location data. For example, the computer implemented method may be adapted to related events if the event data for those events indicates that the events occurred within a certain distance. As such, the computer implemented method is advantageously adapted to match event data that do not match exactly in terms of event location.

Preferably, the step of selectively relating the first event data and the second event data in accordance with the distance data comprises the steps of:
receiving distance threshold data representing a distance threshold; and
selectively relating the first event data and the second event data in accordance with the distance data and the distance threshold data.

Advantageously, the computer implemented method is adapted for being configured as to the location proximity within which events should be matched. The configuration may, for example, be a global configuration or a user configurable proximity. In this manner, a chronicler may advantageously input configuration data of, for example, 100 km such that the computer implemented method only relates other events occurring within 100 km of the chronicler's events.

Preferably, at least one of the first location data and the second location data comprise address data representing a street address.

Preferably, the computer implemented method further comprises the step of resolving the address data into co-ordinate data.

Advantageously, the computer implemented method is adapted for receiving location data in the form of street address data. Such format is a user friendly format and does not require a chronicler to use awkward co-ordinate data when inputting event location data. The computer implemented method may advantageously be adapted for converting the street address data into co-ordinate data, for example, using a geolocation web service. The location data in co-ordinate data advantageously aids in the computation of distances and other geolocation calculations.

Preferably, at least one of the first location data and the second location data comprise landmark data representing a landmark.

Advantageously, the computer implemented method is adapted for receiving a variety of event location data. In this case, the landmark location data is an intuitive and user friendly format of location data in that it does not require a chronicler to ascertain and input either street address data or co-ordinate data.

Preferably, the first event data comprises first time and date data representing a time and date of the first event; and
the second event data comprises second time and date data representing a time and date of the second event, and wherein:
the step of selectively relating the first event data and the second event data in accordance with the first event data and the second event data comprises the step of:
selectively relating the first event data and the second event data in accordance with the first time and date data and the second time and date data.

Advantageously, the computer implemented method is adapted for relating events in time in accordance with the first time and date data and the second time and date data. For example, should a first event have occurred on 15 Mar. 2011, the computer implemented method may be adapted for identifying other events occurring on the same date.

Preferably, the step of selectively relating the first event data and the second event data in accordance with the first time and date data and the second time and date data comprises the steps of:
determining time period data in accordance with the first time and date data and the second time and date data representing a time period between the time and date of the first event and the time and date of the second event; and
selectively relating the first event data and the second event data in accordance with the time period data.

Advantageously, the computer implemented method is adapted for matching events not occurring contemporaneously. For example, where an event took place on a particular day within a month, the computer implemented method may advantageously be adapted for identifying other events occurring within the same month.

Preferably, the step of selectively relating the first event data and the second event data in accordance with the time period data comprises the steps of:
receiving time period threshold data representing a time period threshold; and
selectively relating the first event data and the second event data in accordance with the time period data and the time period threshold data.

Advantageously, the computer implemented method is adapted for being configured as to the time proximity within which events should be matched. The configuration may, for example, be a global configuration or a user configurable proximity. In this manner, a chronicler may advantageously input configuration data of, for example 1 month, such that the computer implemented method only relates other events occurring within 1 month of the chronicler's events.

Preferably, the computer implemented method further comprises the steps of:
receiving certification data representing that the first event data is accurate; and
recording first event certification data representing that the first event is certified.

Advantageously, the computer implemented method is adapted for recording events that are certified as being accurate. For example, one or more historians may review the event data for confirmation that the event data is accurate. Upon receiving certification data from a historian that an event is accurate, the computer implemented method may be adapted to display that the event has been certified by a historian. In this manner, other chroniclers may advantageously rely on the event data knowing the event data is accurate.

Preferably, the computer implemented method further comprises the steps of:
receiving chapter data representing that the first event data belongs to a chapter; and
recording first event chapter data representing that the first event belongs to the chapter.

Advantageously, the computer implemented method is adapted for categorising related event data into chapters. Such chapter categorisation conveniently organizes related events. For example, where a chronicler embarks on a European tour, all of the events occurring during the tour may conveniently be organized into a ‘European tour’ chapter. Furthermore, the computer implemented method may be adapted to share chapters with other chroniclers, saving a chronicler from having to configure each event separately.

Preferably, the computer implemented method further comprises the step of:
generating book data comprising the chapter data.

Advantageously, the computer implemented method is adapted for compiling human readable book data comprising one or more chapters. For example, a chronicler may request that all events occurring in Berlin during world war two be compiled into a portable document format (PDF) book.

Preferably, the first event data comprises first user data representing a first user; and
the second event data comprises second user data representing a second user, and wherein:
the step of selectively relating the first event data and the second event data in accordance with the first event data and the second event data comprises the step of:
selectively relating first user data and the second user data in accordance with the first event data and the second event data.

Advantageously, the computer implemented method is adapted for relating chroniclers in accordance with the event data. For example, a user inputting event data relating to a world war two object may be introduced to other chroniclers having a similar interest in world war two by the computer implemented method.

According to another aspect, there is provided a web server for selectively relating event data, the web server comprising:
a processor for processing digital data;
a memory device for storing digital data including computer program code and being coupled to the processor; and
a network interface for sending and receiving digital data and being coupled to the processor, wherein
the network interface is controlled by the computer program code to receive first event data representing a first event and receiving second event data representing a second event; and
selectively relate the first event data and the second event data in accordance with the first event data and the second event data.

Preferably, the first event data comprises first location data representing a location of the first event; and
the second event data comprises second location data representing a location of the second event, and wherein:
the processor is controlled by the computer program code to selectively relate the first event data and the second event data in accordance with the first location data and the second location data.

Preferably, the processor is controlled by the computer program code to determine distance data in accordance with the first location data and the second location data representing a distance between the location of the first event and the location of the second event and selectively relate the first event data and the second event data in accordance with the distance data.

Preferably, the network interface is controlled by the computer program code to receive distance threshold data representing a distance threshold; and
the processor is controlled by the computer program code to selectively relate the first event data and the second event data in accordance with the distance data and the distance threshold data.

Preferably, at least one of the first location data and the second location data comprise address data representing a street address.

Preferably, the processor is controlled by the computer program code resolve the address data into co-ordinate data.

Preferably, at least one of the first location data and the second location data comprise landmark data representing a landmark.

Preferably, the processor is controlled by the computer program code to resolve the landmark data into co-ordinate data.

Preferably, the first event data comprises first time and date data representing a time and date of the first event; and
the second event data comprises second time and date data representing a time and date of the second event, and wherein:
the processor is controlled by the computer program code to selectively relate the first event data and the second event data in accordance with the first time and date data and the second time and date data.

Preferably, the processor is controlled by the computer program code to determine time period data in accordance with the first time and date data and the second time and date data representing a time period between the time and date of the first event and the time and date of the second event and selectively relate the first event data and the second event data in accordance with the time period data.

Preferably, the network interface is controlled by the computer program code to receive time period threshold data representing a time period threshold; and
the processor is controlled by the computer program code to selectively relate the first event data and the second event data in accordance with the time period data and the time period threshold data.

Preferably, the network interface is controlled by the computer program code to receive certification data representing that the first event data is accurate; and the processor is controlled by the computer program code to record first event certification data representing that the first event is certified.

Preferably, the network interface is controlled by the computer program code to receive chapter data representing that the first event data belongs to a chapter; and the processor is controlled by the computer program code to record first event chapter data representing that the first event belongs to the chapter.

Preferably, the processor is controlled by the computer program code to generate book data comprising the chapter data.

Preferably, the first event data comprises first user data representing a first user; and
the second event data comprises second user data representing a second user, and wherein:
the processor is controlled by the computer program code to selectively relate the first user data and the second user data in accordance with the first event data and the second event data

According to another aspect, there is provided a client computing device for selectively relating event data comprising a network interface for sending and receiving digital data and being coupled to a web server as described above.

According to another aspect, there is provided a computer readable storage medium for selectively relating event data having computer program code instructions recorded thereon, the computer program code instructions being executable by a computer and comprising:
instructions for receiving first event data representing a first event;
instructions for receiving second event data representing a second event; and
instructions for selectively relating the first event data and the second event data in accordance with the first event data and the second event data.

Preferably, the first event data comprises first location data representing a location of the first event; and
the second event data comprises second location data representing a location of the second event, and wherein:
the instructions for selectively relating the first event data and the second event data in accordance with the first event data and the second event data comprises:
instructions for selectively relating the first event data and the second event data in accordance with the first location data and the second location data.

Preferably, the instructions for selectively relating the first event data and the second event data in accordance with the first location data and the second location data comprises:
instructions for determining distance data in accordance with the first location data and the second location data representing a distance between the location of the first event and the location of the second event; and
instructions for selectively relating the first event data and the second event data in accordance with the distance data.

Preferably, the instructions for selectively relating the first event data and the second event data in accordance with the distance data comprises:
instructions for receiving distance threshold data representing a distance threshold; and
instructions for selectively relating the first event data and the second event data in accordance with the distance data and the distance threshold data.

Preferably, at least one of the first location data and the second location data comprise address data representing a street address.

Preferably, the computer readable storage medium further comprises instructions for resolving the address data into co-ordinate data.

Preferably, at least one of the first location data and the second location data comprise landmark data representing a landmark.

Preferably, the computer readable storage medium further comprises instructions for resolving the landmark data into co-ordinate data.

Preferably, the first event data comprises first time and date data representing a time and date of the first event; and
the second event data comprises second time and date data representing a time and date of the second event, and wherein:
the instructions for selectively relating the first event data and the second event data in accordance with the first event data and the second event data comprises:
instructions for selectively relating the first event data and the second event data in accordance with the first time and date data and the second time and date data.

Preferably, the instructions for selectively relating the first event data and the second event data in accordance with the first time and date data and the second time and date data comprises:
instructions for determining time period data in accordance with the first time and date data and the second time and date data representing a time period between the time and date of the first event and the time and date of the second event; and
instructions for selectively relating the first event data and the second event data in accordance with the time period data.

Preferably, the instructions for selectively relating the first event data and the second event data in accordance with the time period data comprises:
instructions for receiving time period threshold data representing a time period threshold; and
instructions for selectively relating the first event data and the second event data in accordance with the time period data and the time period threshold data.

Preferably, the computer readable storage medium further comprises instructions for receiving certification data representing that the first event data is accurate; and
instructions for recording first event certification data representing that the first event is certified.

Preferably, the computer readable storage medium further comprises instructions for receiving chapter data representing that the first event data belongs to a chapter; and
instructions for recording first event chapter data representing that the first event belongs to the chapter.

Preferably, the computer readable storage medium further comprises instructions for generating book data comprising the chapter data.

Preferably, the first event data comprises first user data representing a first user; and
the second event data comprises second user data representing a second user, and wherein:
the instructions for selectively relating the first event data and the second event data in accordance with the first event data and the second event data comprises:
instructions for selectively relating first user data and the second user data in accordance with the first event data and the second event data.

It should be noted that the system and the computer readable storage medium provide the same or similar advantages as the advantages provided by the corresponding computer implemented method, some of which are described herein. Additionally the system provides the advantage of deployment across a computer network, such as the Internet, providing distribution, access and economy of scale advantages. Furthermore, the computer readable storage medium provides further advantages, such allowing the deployment of computer instructions for installation and execution by one or more computing devices.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a computing device on which the various embodiments described herein may be implemented in accordance with an embodiment of the present invention;

FIG. 2 shows a network of computing devices on which the various embodiments described herein may be implemented in accordance with an embodiment of the present invention;

FIG. 3 shows a computer implemented method for selectively relating event data; and

FIG. 4 shows an exemplary graphical user interface (GUI) for inputting event data.

### DETAILED DESCRIPTION OF SPECIFIC EMBODIMENTS

It should be noted in the following description that like or the same reference numerals in different embodiments denote the same or similar features.

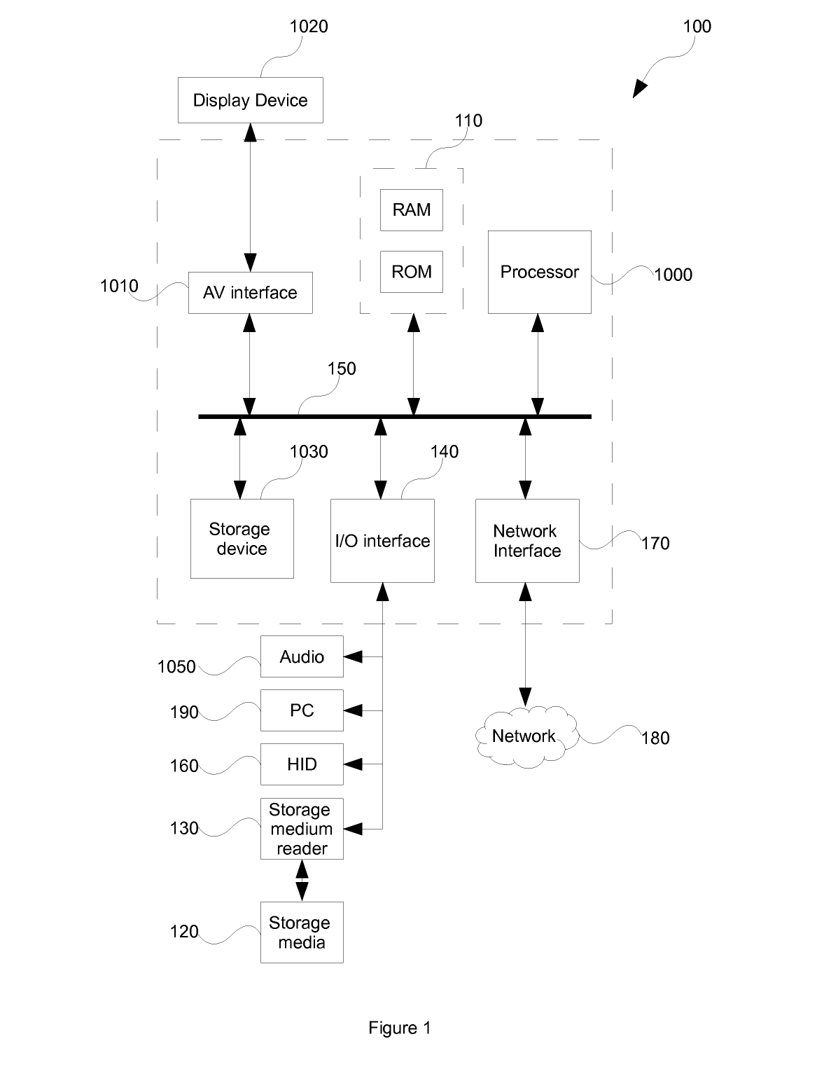

FIG. 1 shows a computing device 100 on which the various embodiments described herein may be implemented. In particular the steps of the method for selectively relating event data may be implemented as computer program code instructions executable by the computing device 100. The computer program code instructions may be divided into one or more computer program code instruction libraries, such as dynamic link libraries (DLL), wherein each of the libraries performs a one or more steps of the method. Additionally, a subset of the one or more of the libraries may perform graphical user interface tasks relating to the steps of the method.

The device 100 comprises semiconductor memory 110 comprising volatile memory such as random access memory (RAM) or read only memory (ROM). The memory 100 may comprise either RAM or ROM or a combination of RAM and ROM.

The device 100 comprises a computer program code storage medium reader 130 for reading the computer program code instructions from computer program code storage media 120. The storage media 120 may be optical media such as CD-ROM disks, magnetic media such as floppy disks and tape cassettes or flash media such as USB memory sticks.

The device further comprises I/O interface 140 for communicating with one or more peripheral devices. The I/O interface 140 may offer both serial and parallel interface connectivity. For example, the I/O interface 140 may comprise a Small Computer System Interface (SCSI), Universal Serial Bus (USB) or similar I/O interface for interfacing with the storage medium reader 130. The I/O interface 140 may also communicate with one or more human input devices (HID) 160 such as keyboards, pointing devices, joysticks and the like. The I/O interface 140 may also comprise a computer to computer interface, such as a Recommended Standard 232 (RS-232) interface, for interfacing the device 100 with one or more personal computer (PC) devices 190. The I/O interface 140 may also comprise an audio interface for communicate audio signals to one or more audio devices 1050, such as a speaker or a buzzer.

The device 100 also comprises a network interface 170 for communicating with one or more computer networks 180. The network 180 may be a wired network, such as a wired Ethernet™ network or a wireless network, such as a Bluetooth™ network or IEEE 802.11 network. The network 180 may be a local area network (LAN), such as a home or office computer network, or a wide area network (WAN), such as the Internet or private WAN.

The device 100 comprises an arithmetic logic unit or processor 1000 for performing the computer program code instructions. The processor 1000 may be a reduced instruction set computer (RISC) or complex instruction set computer (CISC) processor or the like. The device 100 further comprises a storage device 1030, such as a magnetic disk hard drive or a solid state disk drive.

Computer program code instructions may be loaded into the storage device 1030 from the storage media 120 using the storage medium reader 130 or from the network 180 using network interface 170. During the bootstrap phase, an operating system and one or more software applications are loaded from the storage device 1030 into the memory 110. During the fetch-decode-execute cycle, the processor 1000 fetches computer program code instructions from memory 110, decodes the instructions into machine code, executes the instructions and stores one or more intermediate results in memory 100.

The device 100 also comprises a video interface 1010 for conveying video signals to a display device 1020, such as a liquid crystal display (LCD), cathode-ray tube (CRT) or similar display device.

The device 100 also comprises a communication bus subsystem 150 for interconnecting the various devices described above. The bus subsystem 150 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

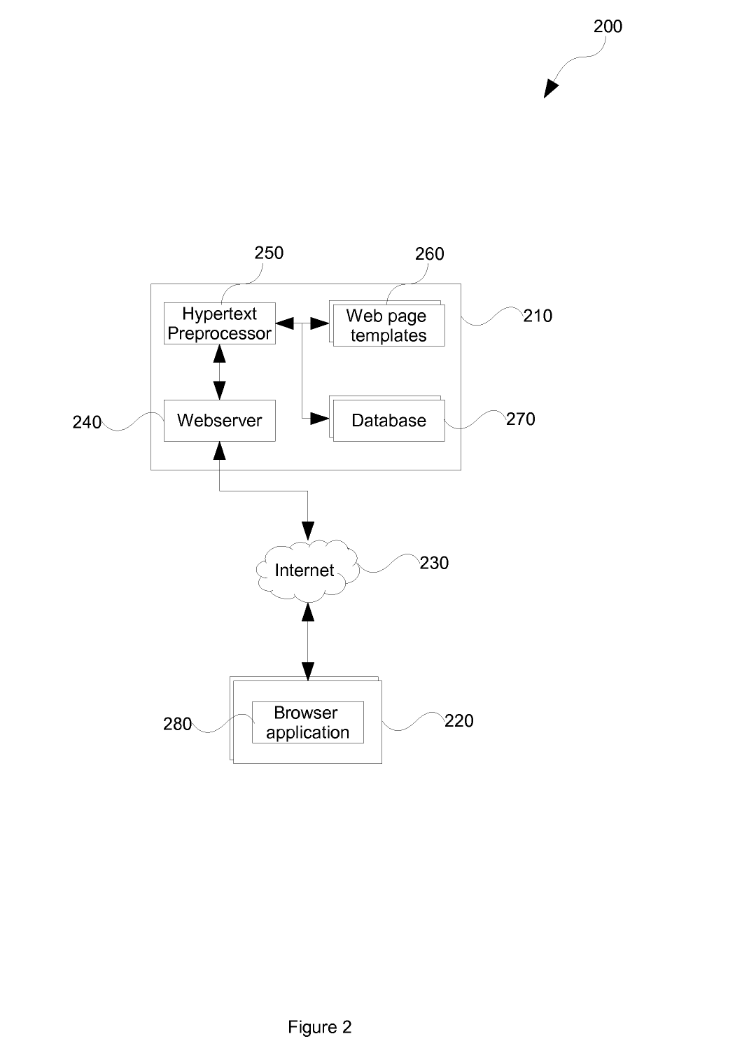

FIG. 2 shows a network 200 of computing devices 100 on which the various embodiments described herein may be implemented. The network 200 comprises a web server 210 for serving web pages to one or more client computing devices 220 over the Internet 230.

The web server 210 is provided with a web server application 240 for receiving requests, such as Hypertext Transfer Protocol (HTTP) and File Transfer Protocol (FTP) requests, and serving hypertext web pages or files in response. The web server application 240 may be, for example the Apache™ or the Microsoft™ IIS HTTP server.

The web server 210 is also provided with a hypertext preprocessor 250 for processing one or more web page templates 260 and data from one or more databases 270 to generate hypertext web pages. The hypertext preprocessor may, for example, be the PHP: Hypertext Preprocessor (PHP) or Microsoft Asp™ hypertext preprocessor. The web server 210 is also provided with web page templates 260, such as one or more PHP or ASP files.

Upon receiving a request from the web server application 240, the hypertext preprocessor 250 is operable to retrieve a web page template, from the web page templates 260, execute any dynamic content therein, including updating or loading information from the one or more databases 270, to compose a hypertext web page. The composed hypertext web page may comprise client side code, such as Javascript, for Document Object Model (DOM) manipulating, asynchronous HTTP requests and the like.

Client computing devices 220 are provided with a browser application 280, such as the Mozilla Firefox™ or Microsoft Internet Explorer™ browser applications. The browser application 280 requests hypertext web pages from the web server 210 and renders the hypertext web pages on a display device 1020.

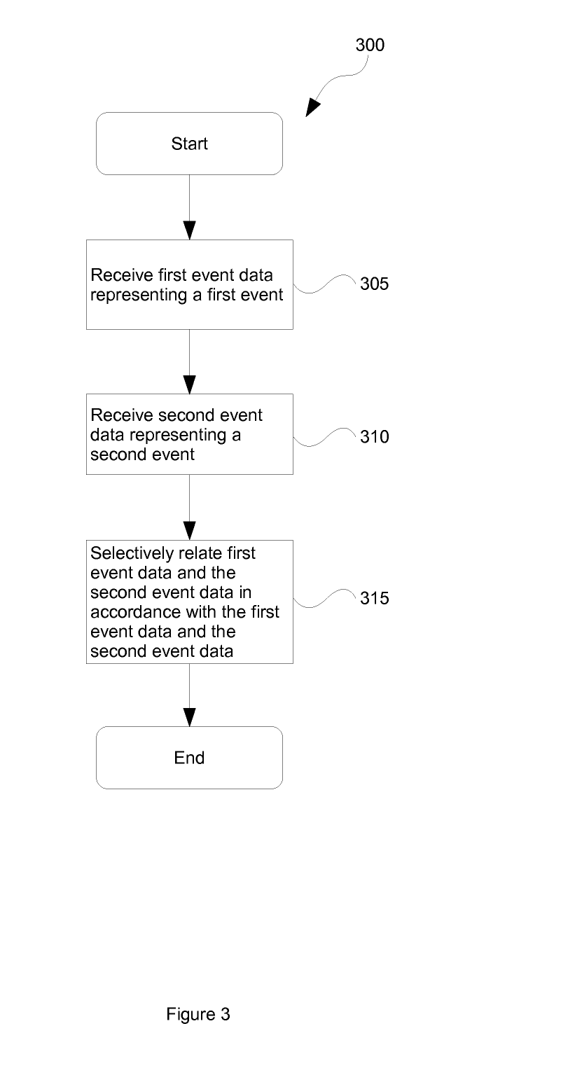

FIG. 3 shows a computer implemented method 300 for selectively relating event data. As will be described in further detail below, chroniclers may use system 200 for the purposes of recording chronicles, referred to herein as events. As will also be further described below, the system 200 advantageously allows for events to be selectively related. The method 300 is executed by one or more computing devices 100 and in particular one or more computing devices 100 connected across the Internet 230 as substantially shown in FIG. 2.

Even data as described herein typically relates to historical events. However, future event data is equally applicable wherein the web server 210 is adapted for selectively relating event data occurring in the future.

The term chronicler as used herein should not be interpreted as limiting the system 200 to formal or academic purposes. While the system 200 may indeed be used to chronicle and verify events, for example relating to world war two, the system 200 may also be used within an every-day social networking context, wherein one or more users upload their social event data, such as attendance of a house warming party. Other applications are also applicable.

During the user sign-up process, a user may be categorised as a chronicler, a historian or a moderator. As will be described in further detail below, a chronicler is able to input event data relating to one or more events.

Also as will be described in further detail below a historian user is able to verify event data uploaded by one or more chroniclers. If a user requests a historian-type user account, the web server 210 may be adapted to send notification data to the administrator user for approval of the historian user account.

A moderator user is a user able to moderate a designated user account. A moderator account may be a standard moderator account, wherein the standard moderator may freely moderate the designated account event data as if the designated account was the moderator's personal account. A moderator account may also be a guardian moderator account wherein the guardian moderator may edit chapter data (as described below) security settings but not event data.

The method 300 starts at steps 305 where first event data representing a first event is received by the web server 210. The first event data may be received by the web server 210 from a chronicler operating browser application 280 software on a client computing device 220.

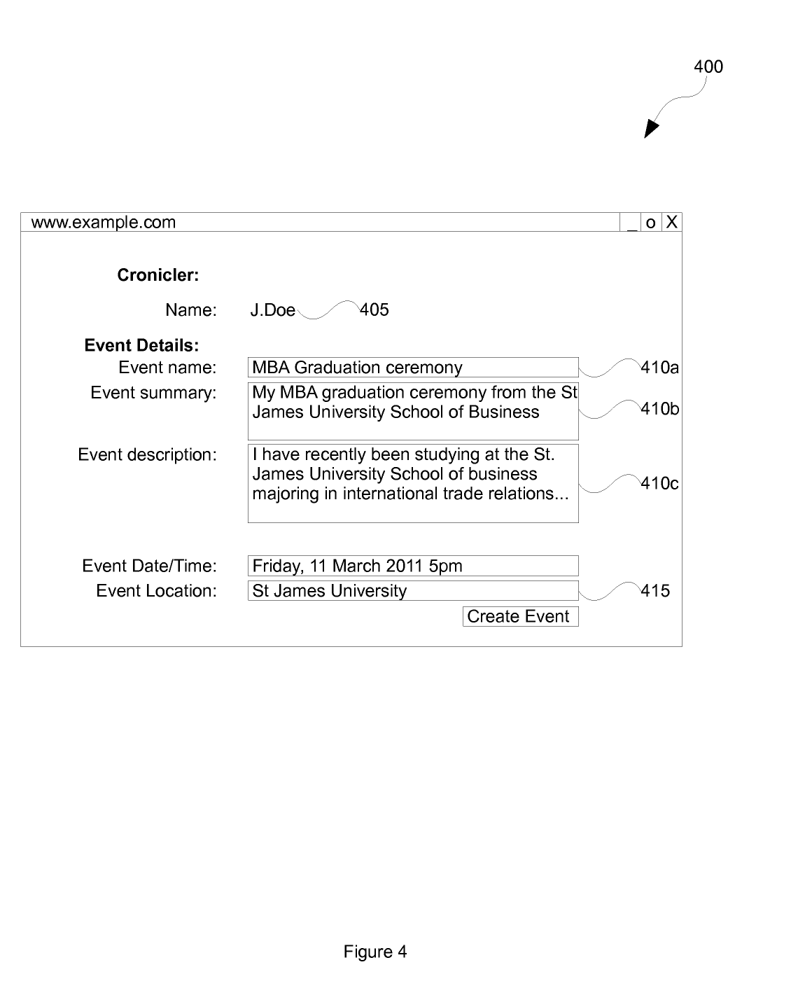

FIG. 4 shows an exemplary graphical user interface (GUI) 400 for inputting event data. The GUI 400 may comprise chronicler identification 405 identifying a chronicler currently logged on or authenticated with the web server 210.

The GUI 400 also comprises event description input means 410. In the example given in FIG. 4, the event description input means 410 comprises event name input means 410a for inputting the name of the event. Also provided is event summary input means 410b for inputting summary data of the event and event detail input means 410c. The summary data is typically a maximum of about 150 characters in length.

In certain embodiments, a chronicler, when inputting an event using the GUI 400 may use only certain of the event description input means 410 to input event description data. For example, where a chronicler attends a house warming party, the chronicler may input only the title of the event and a summary of the event. At a later date, the chronicler may edit the event data, including inputting event description data such as the names of the other attendees.

While the example given in FIG. 4 is related to an event associated with a chronicler, it should be noted that the computer implemented method 300 may receive event information for any object including individuals, groups, companies or objects having historical significance. For example, should a chronicler find information relating to the discovery of a missing world war two war plane, the chronicler may input event data relating to the war plane, such as the date and time and/or location of manufacture of the plane.

Furthermore, while the event description input means 410 given in FIG. 4 are text data input fields, other types of event description data may be provided, such as image, audio and video data. For example, a chronicler may upload image data to the web server 210 representing a photograph of servicemen taken during the Gallipoli campaign. In this manner, the chronicler may input the names of the recognizable service men in the photo and the date and time when and/or the location where the photograph was taken.

At step 310 of method 300, the web server is adapted to receive second event data representing a second event. The second event data may be received from the same chronicler who supplied the first event data or from another chronicler altogether.

At step 315 of method 300, the web server 210 is adapted to selectively relate the first event data and the second event data in accordance with the first event data and the second event data.

In this manner, the web server 210 may be adapted to find relationships between events. Using the example above of the world war two war plane, the web server 210, having received event information relating to the war plane may be adapted to, for example, identify the pilot of the war plane using the event information of the war plane and the event information of the pilot. In this manner, a chronicler, having input event data relating to the pilot, may be notified by the web server 210 of the existence of the related war plane event. Where more than one events are related, the web server 210 may be adapted to cause display device 1020 to display the number of related events.

There are various methods by which the web server 210 may selectively relate the first event data and the second event data in accordance with the first event data and the second event data.

In one embodiment, the web server 210 may be adapted to selectively relate the first event data and the second event data in accordance with location data. For example, GUI 400 comprises event location input means 415 for inputting event location data.

In this manner, the first event data comprises first location data representing a location of the first event and the second event data comprises second location data representing a location of the second event. As such, when the web server 210 is selectively relating the first event data and the second event data in accordance with the first event data and the second event data, the web server 210 may be adapted to selectively relate the first event data and the second event data in accordance with the first location data and the second location data.

For example, where a first chronicler enters first event data to the effect that the first chronicler was in Paris, and a second chronicler enters second event data to the effect that the second chronicler was also in Paris, the web server 210 may be adapted to relate the first event data and the second event data.

It should be noted that the selective relation of event data need not necessarily occur at the input of second event data. For example, in certain embodiments, upon receiving first event data from a chronicler, the web server 210 may be operable to retrieve second event data from a database, the second event data having been recorded prior to the receipt of the first event data.

In one embodiment, the web server 210 may be adapted to determine distance data in accordance with the first location data and the second location data representing a distance between the location of the first event and the location of the second event and selectively relate the first event data and the second event data in accordance with the distance data.

In this manner, the web server 210 may be adapted to match those events having adjacent location data. For example, first event location data may indicate that the first event took place in Sydney while the second event location data may indicate that the second event took place in Melbourne. As such, the web server 210 may be adapted to calculate the distance between Sydney and Melbourne and selectively relate the event data accordingly.

In one embodiment, the web server may be adapted to receive distance threshold data. For example, a chronicler may only want to know of the events that took place within a 100 km radius. As such, the web server 210 may be adapted to receive distance threshold data representing a distance threshold and identifying the second event data as being related to the first event in accordance with the distance data and the distance threshold data.

The web server may be adapted to receive event location data in the form of street address data. For instance a chronicler may input event data for an event that took place at 52 Wallaby Way, Sydney. In this manner, the web server may be adapted to resolve the street address data into map co-ordinate data, for example, by using a geo-location web service. In another embodiment, event location data can be received via the GPS functionality on a mobile device such as a mobile phone or tablet.

In another embodiment, the web server 210 may be adapted to receive event location data in the form of landmark data representing a landmark. In the exemplary embodiment given in FIG. 4, the event location input means 415 is adapted to receive landmark data representing a landmark. In this example the landmark is ‘St James University’. As such, the web server 210 database 270 may be provided with a lookup table for resolving landmark data into co-ordinate data. In alternative embodiments, the web server 210 may be adapted to make use of a geolocation web service to resolve the landmark data into co-ordinate data.

The chronicler may configure the chronicler's user account such that new event data is assigned a default location. For example, where a chronicler lives in Sydney, the chronicler may configure the chronicler's account such that all new events, unless specified otherwise, are allocated event location data representing Sydney.

In another embodiment, the web server 210 may be adapted to selectively relate the first event data and the second event data in accordance with time and date data. For example, GUI 400 comprises event date and time input means 415 for inputting event date and time data.

In this manner, the first event data comprises first time and date data representing a time and date of the first event and the second event data comprises second time and date data representing a time and date of the second event. As such, the web server 210, in selectively relating first event data and the second event data in accordance with the first event data and the second event data, may selectively relate the first event data and the second event data in accordance with the first time and date data and the second time and date data.

For example, if a first chronicler enters first event data indicating that the first chronicler attended St James University during the summer of 1969, and a second chronicler enters second event data indicating that the second chronicler also attended St James university during the summer of 1969, the web server may be adapted to selectively relate the first event data and the second event data.

It should be noted that the web server 270 may be adapted to accept time and date data of varying precision. For example, the web server 270 may, at one end accept date and time data representing decade, suitable, for example, representing the time of the great depression, and at the other, accept date and time data representing a date and time to the nearest second, suitable, for example, for representing the exact time at which president Kennedy was shot.

The web server 210 may be adapted also to selectively relate events not occurring exactly simultaneously. For example, where a chronicler input event time and date data representing that the chronicler was in Dealey Plaza, Dallas, Tex. one week after the shooting of president Kennedy, the web server 210 may be adapted to selectively relate the two events.

In this manner, the web server 210 may be adapted for determining time period data in accordance with the first time and date data and the second time and date data representing a time period between the time and date of the first event and the time and date of the second event and selectively relating first event data and the second event data in accordance with the time period data.

The time period may be set using, for example, the web server 210 configuration file or configured by a chronicler. For example, a chronicler may configure the chronicler's user account such that event data is selectively related according to any one of the following:
1. No selective relation
2. Selective relation by year data
3. Selective relation by year and month data
4. Selective relation by year and month and day data
5. Selective relation by year and month and day and hour data
6. Selective relation by year and month and day and hour and minute data

As such, the web server 210 may be adapted for receiving time period threshold data representing a time period threshold and identifying the second event data as being related to the first event in accordance with the time period data and the time period threshold data.

While in the examples given above the web server is adapted for selectively relating the first event data and the second event data in accordance with the event location data or the event date and time data, it should be noted that, in a preferred embodiment, the web server 210 may be adapted to selectively relate first event data and second event data in accordance with both the event location data and the time and date data.

In certain embodiments, the web server 210 may be adapted to relate events in accordance with event data other than location data or time and date data. For example, where a chronicler uploads a photo from a house warming party and tags one or more attendees of the party, the web server 210 may be adapted to use the names of the attendees to identify other events also attended by the attendees.

It should also be noted that in certain embodiments, a single chronicler need not necessarily enter the event location data and the event time and date data. For example, a first chronicler may find a world war two relic and enter the location where the relic was found. Later, a second chronicler, recognizing the relic, may input time and date data representing the time and date the relic was manufactured.

In a further preferred embodiment, a chronicler having input event data may request that the event data be certified by a historian as being accurate event data. Should the event data be certified by the historian as being accurate, the web server 210 may be adapted to cause the display device 210 to display a certification symbol in conjunction with the event data to indicate that the event data has been certified.

For example, a chronicler may enter event data relating to world war two. After having input the event data, the chronicler may select a historian from a set of historians and request the historian to certify the event data. For example, the web server 210 may be adapted for receiving certification data from a historian representing that the first event data is accurate and recording first event certification data representing that the first event is certified. The certification process may be a paid process wherein a chronicler pays the historian to certify the chronicler's event data. Alternatively, the web server 210 may implement a moderation policy wherein one or more historians, either on a voluntary or employment basis, selectively verify one or more event data as being accurate. The web server 210 may be adapted to lock certified event data such that the event data cannot be subsequently modified. During the certification process, if a historian refuses to certify event data on account of an inaccuracy, the event data may be unlocked and referred back to the chronicler for editing.

In one embodiment, the web server 210 may be adapted to record the number of events certified by a historian. In this manner, a diligent historian may be promoted by the web server 210 when a chronicler is presented with a list of historians for selection.

In a further embodiment, the web server 210 may be adapted to group one or more event data in to chapters for categorisation purposes. For example, where a chronicler embarks on a European tour and records one or more events during the course of the tour, the web server 210 may be adapted to categorise those events as belonging to the ‘European tour’ chapter. The web server 210 may be adapted to automatically categorise the one or more events, such as for example categorising the events according to country location data. Alternatively, the web server 210 may be adapted for receiving event categorisation data from a chronicler. In this manner, the web server 210 may be adapted for receiving chapter data representing that the first event data belongs to a chapter and recording first event chapter data representing that the first event belongs to the chapter.

A chronicler may configure the visibility of the one or more chapters. For example, a chronicler may configure the chronicler's account such that all chapters belonging to the chronicler are visible or invisible to one or more other chroniclers. Alternatively, the chronicler may configure the visibility of each chapter individually.

In a yet further embodiment, the web server 210 may be adapted to generate book data comprising one or more event data. The book data creation process usually requires the filtering of one or more event data and the compilation of the filtered event data into the book data. The book data may, in some embodiments, be generated in portable document format (PDF) for convenience and ease of use. For example, a chronicler may request that the web server 210 generate book data comprising all of event data occurring after midday during the ‘European tour’ chapter. In another example, a chronicler may request the web server 210 to generate book data comprising all event data occurring during world war two in Berlin.

In a further embodiment, the web server 210 may be adapted to relate two or more chroniclers in accordance with the event data submitted by the chroniclers. For example, whereas in existing social networking systems a user typically has a single generic social network, the web server 210 may be adapted to record multiple social networks for a chronicler.

For example, where a user has input event data relating to world war two, the web server 210 may be adapted to suggest other chroniclers having input event data relating to world war two with which the chronicler may form a social network. In this manner, a first social network may be created for the chronicler. Furthermore, should the chronicler, for example, input event data relating to a particular medical condition, the web server 210 may be adapted to suggest other chroniclers suffering from the same medical condition with which the chronicler may form a second social network. It certain embodiments, the web server 210 may be adapted to keep separate social networks private, such that chroniclers linked to a chronicler by a first network may not be able to see the chroniclers linked to the chronicler on a second social network.

In one embodiment, a chronicler may select one or more chapters for inclusion within a social network. Using the examples given above, where the chronicler is a member of a social network sharing a medical ailment, the chronicler may select the ‘European tour’ chapter for inclusion within the social network such that the other members of the medical ailment social network may view the events from the European tour. The web server 210 may be further adapted for sending update notification data to the members of a social network when an event of a chapter included within the network is updated.

In this manner, the first event data comprises first user data representing a first user and the second event data comprises second user data representing a second user. As such, in selectively relating first event data and the second event data in accordance with the first event data and the second event data, the web server 210 may be adapted for selectively relating first user data and the second user data in accordance with the first event data and the second event data

As such, the web server 210 may (privacy setting permitting) be adapted to, upon receipt of event data, cause display device 1020 to display chronicler data relating to one or more other chroniclers related to the event data.

### Interpretation

### Historian

This term refers to a person or body that is suitably qualified and/or recognised as having the authority to be able to validate and/or certify the occurrence of that event.

In Accordance with

As described herein, ‘in accordance with’ may also mean ‘as a function of’.

### Wireless:

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes:

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium:

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium:

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means for Carrying Out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the historical software industry.

1. A web server for selectively relating event data, the web server comprising:
a processor for processing digital data;
a memory device for storing digital data including computer program code and being coupled to the processor; and
a network interface for sending and receiving digital data and being coupled to the processor, wherein
the network interface is controlled by the computer program code to receive first event data representing a first event and receiving second event data representing a second event; and
the processor is controlled by the computer program code to selectively relate the first event data and the second event data in accordance with the first event data and the second event data.

2. A web server as claimed in claim 1, wherein:
the first event data comprises first location data representing a location of the first event; and
the second event data comprises second location data representing a location of the second event, and wherein:
the processor is controlled by the computer program code to selectively relate the first event data and the second event data in accordance with the first location data and the second location data.

3. A web server as claimed in claim 2, wherein the processor is controlled by the computer program code to determine distance data in accordance with the first location data and the second location data representing a distance between the location of the first event and the location of the second event and selectively relate the first event data and the second event data in accordance with the distance data.

4. A web server as claimed in claim 3, wherein the network interface is controlled by the computer program code to receive distance threshold data representing a distance threshold; and
the processor is controlled by the computer program code to selectively relate the first event data and the second event data in accordance with the distance data and the distance threshold data.

5. A web server as claimed in claim 2, wherein at least one of the first location data and the second location data comprise address data representing a street address.

6. A web server as claimed in claim 5, wherein the processor is controlled by the computer program code resolve the address data into co-ordinate data.

7. A web server as claimed in claim 2, wherein at least one of the first location data and the second location data comprise landmark data representing a landmark.

8. A web server as claimed in claim 7, wherein the processor is controlled by the computer program code to resolve the landmark data into co-ordinate data.

9. A web server as claimed in claim 1, wherein:
the first event data comprises first time and date data representing a time and date of the first event; and
the second event data comprises second time and date data representing a time and date of the second event, and wherein:
the processor is controlled by the computer program code to selectively relate the first event data and the second event data in accordance with the first time and date data and the second time and date data.

10. A web server as claimed in claim 9, wherein the processor is controlled by the computer program code to determine time period data in accordance with the first time and date data and the second time and date data representing a time period between the time and date of the first event and the time and date of the second event and selectively relate the first event data and the second event data in accordance with the time period data.

11. A web server as claimed in claim 10, wherein the network interface is controlled by the computer program code to receive time period threshold data representing a time period threshold; and
the processor is controlled by the computer program code to selectively relate the first event data and the second event data in accordance with the time period data and the time period threshold data.

12. A web server as claimed in claim 1, wherein the network interface is controlled by the computer program code to receive certification data representing that the first event data is accurate; and the processor is controlled by the computer program code to record first event certification data representing that the first event is certified.

13. A web server as claimed in claim 1, wherein the network interface is controlled by the computer program code to receive chapter data representing that the first event data belongs to a chapter; and the processor is controlled by the computer program code to record first event chapter data representing that the first event belongs to the chapter.

14. A web server as claimed in claim 13, wherein the processor is controlled by the computer program code to generate book data comprising the chapter data.

15. A web server as claimed in claim 1, wherein:
the first event data comprises first user data representing a first user; and
the second event data comprises second user data representing a second user, and wherein:
the processor is controlled by the computer program code to selectively relate the first user data and the second user data in accordance with the first event data and the second event data

16. A client computing device for selectively relating event data comprising a network interface for sending and receiving digital data and being coupled to a web server as claimed in claim 1.

17. A computer implemented method for selectively relating event data, the method comprising the steps of:
receiving first event data representing a first event;
receiving second event data representing a second event; and
selectively relating the first event data and the second event data in accordance with the first event data and the second event data.

18. A computer implemented method as claimed in claim 17, wherein:
the first event data comprises first location data representing a location of the first event; and
the second event data comprises second location data representing a location of the second event, and wherein:
the step of selectively relating the first event data and the second event data in accordance with the first event data and the second event data comprises the step of:
selectively relating the first event data and the second event data in accordance with the first location data and the second location data.

19. A computer implemented method as claimed in claim 18, wherein the step of selectively relating the first event data and the second event data in accordance with the first location data and the second location data comprises the steps of:
determining distance data in accordance with the first location data and the second location data representing a distance between the location of the first event and the location of the second event; and
selectively relating the first event data and the second event data in accordance with the distance data.

20. A computer implemented method as claimed in claim 19, wherein the step of selectively relating the first event data and the second event data in accordance with the distance data comprises the steps of:
receiving distance threshold data representing a distance threshold; and
selectively relating the first event data and the second event data in accordance with the distance data and the distance threshold data.

21. A computer implemented method as claimed in claim 18, wherein at least one of the first location data and the second location data comprise address data representing a street address.

22. A computer implemented method as claimed in claim 21, further comprising the step of resolving the address data into co-ordinate data.

23. A computer implemented method as claimed in claim 18, wherein at least one of the first location data and the second location data comprise landmark data representing a landmark.

24. A computer implemented method as claimed in claim 23, further comprising the step of resolving the landmark data into co-ordinate data.

25. A computer implemented method as claimed in claim 17, wherein:
the first event data comprises first time and date data representing a time and date of the first event; and
the second event data comprises second time and date data representing a time and date of the second event, and wherein:
the step of selectively relating the first event data and the second event data in accordance with the first event data and the second event data comprises the step of:
selectively relating the first event data and the second event data in accordance with the first time and date data and the second time and date data.

26. A computer implemented method as claimed in claim 25, wherein the step of selectively relating the first event data and the second event data in accordance with the first time and date data and the second time and date data comprises the steps of:
determining time period data in accordance with the first time and date data and the second time and date data representing a time period between the time and date of the first event and the time and date of the second event; and
selectively relating the first event data and the second event data in accordance with the time period data.

27. A computer implemented method as claimed in claim 26, wherein the step of selectively relating the first event data and the second event data in accordance with the time period data comprises the steps of:
receiving time period threshold data representing a time period threshold; and
selectively relating the first event data and the second event data in accordance with the time period data and the time period threshold data.

28. A computer implemented method as claimed in claim 17, further comprising the steps of:
receiving certification data representing that the first event data is accurate; and
recording first event certification data representing that the first event is certified.

29. A computer implemented method as claimed in claim 17, further comprising the steps of:
receiving chapter data representing that the first event data belongs to a chapter; and
recording first event chapter data representing that the first event belongs to the chapter.

30. A computer implemented method as claimed in claim 29, further comprising the step of:
generating book data comprising the chapter data.

31. A computer implemented method as claimed in claim 17, wherein:
the first event data comprises first user data representing a first user; and
the second event data comprises second user data representing a second user, and wherein:
the step of selectively relating the first event data and the second event data in accordance with the first event data and the second event data comprises the step of:
selectively relating first user data and the second user data in accordance with the first event data and the second event data.

32. A computer readable storage medium for selectively relating event data having computer program code instructions recorded thereon, the computer program code instructions being executable by a computer and comprising:
instructions for receiving first event data representing a first event;
instructions for receiving second event data representing a second event; and
instructions for selectively relating the first event data and the second event data in accordance with the first event data and the second event data.

33. A computer readable storage medium as claimed in claim 32, wherein:
the first event data comprises first location data representing a location of the first event; and
the second event data comprises second location data representing a location of the second event, and wherein:
the instructions for selectively relating the first event data and the second event data in accordance with the first event data and the second event data comprises:
instructions for selectively relating the first event data and the second event data in accordance with the first location data and the second location data.

34. A computer readable storage medium as claimed in claim 33, wherein the instructions for selectively relating the first event data and the second event data in accordance with the first location data and the second location data comprises:
instructions for determining distance data in accordance with the first location data and the second location data representing a distance between the location of the first event and the location of the second event; and
instructions for selectively relating the first event data and the second event data in accordance with the distance data.

35. A computer readable storage medium as claimed in claim 34, wherein the instructions for selectively relating the first event data and the second event data in accordance with the distance data comprises:
instructions for receiving distance threshold data representing a distance threshold; and
instructions for selectively relating the first event data and the second event data in accordance with the distance data and the distance threshold data.

36. A computer readable storage medium as claimed in claim 33, wherein at least one of the first location data and the second location data comprise address data representing a street address.
